(19) United States
(12) Patent Application Publication
(10) Pub. No.: US 2025/0298183 A1
(43) Pub. Date: Sep. 25, 2025

(54) MULTICORE FIBER AND MULTICORE FIBER MANUFACTURING METHOD

(71) Applicant: FURUKAWA ELECTRIC CO., LTD., Tokyo (JP)

(72) Inventors: Masanori TAKAHASHI, Tokyo (JP); Yusuke MATSUNO, Tokyo (JP); Ryuichi SUGIZAKI, Tokyo (JP)

(73) Assignee: FURUKAWA ELECTRIC CO., LTD., Tokyo (JP)

(21) Appl. No.: 19/078,328

(22) Filed: Mar. 13, 2025

(30) Foreign Application Priority Data
Mar. 22, 2024 (JP) 2024-045987

(51) Int. Cl. G02B 6/02

(52) U.S. Cl. CPC G02B 6/02042; G02B 6/02314

(57) ABSTRACT

A multicore fiber includes: a plurality of core portions; a cladding portion surrounding outer peripheries of the plurality of core portions and having a refractive index lower than the plurality of core portions; and a plurality of deformation correction portions arranged inside the cladding portion. The plurality of core portions are arranged in a first radial direction in a cross-section perpendicular to a longitudinal direction of the multicore fiber, and the plurality of deformation correction portions are arranged in a second radial direction substantially orthogonal to the first radial direction, in the cross-section.

This application claims the benefit of priority from Japanese Patent Application No. 2024-045987 filed on Mar. 22, 2024, the entire contents of which are incorporated herein by reference.

### BACKGROUND

The present disclosure relates to a multicore fiber and a multicore fiber manufacturing method.

As a multicore fiber, a multicore fiber including two core portions is known (refer to JP 2023-518466 A). The two core portions are arranged in a predetermined radial direction in a cross-section perpendicular to a longitudinal direction of the multicore fiber. The multicore fiber configured as described above is also called a two-core multicore fiber.

### SUMMARY

This type of multicore fiber has a cross-section with low rotational symmetry, and disadvantageously, tends to have a non-circular cross-sectional shape. The non-circular cross-sectional shape may cause problems of decrease in accuracy of a clad diameter, deterioration of polarization mode dispersion (PMD) characteristics due to the non-circular core portion, and the like.

There is a need for a multicore fiber that is inhibited from having a non-circular cross-sectional shape and a manufacturing method of the multicore fiber.

According to one aspect of the present disclosure, there is provided a multicore fiber including: a plurality of core portions; a cladding portion surrounding outer peripheries of the plurality of core portions and having a refractive index lower than the plurality of core portions; and a plurality of deformation correction portions arranged inside the cladding portion, wherein the plurality of core portions are arranged in a first radial direction in a cross-section perpendicular to a longitudinal direction of the multicore fiber, and the plurality of deformation correction portions are arranged in a second radial direction substantially orthogonal to the first radial direction, in the cross-section.

### BRIEF DESCRIPTION OF THE DRAWINGS

FIG. 1 is a schematic cross-sectional view of a multicore fiber according to a first embodiment;

FIG. 2 is an explanatory diagram of a multicore fiber manufacturing method according to a comparative embodiment;

FIG. 3 is an explanatory diagram of a multicore fiber manufacturing method according to the first embodiment;

FIG. 4 is a schematic cross-sectional view of a multicore fiber according to a second embodiment;

FIG. 5 is an explanatory diagram of a multicore fiber manufacturing method according to the second embodiment; and

FIG. 6 is a schematic cross-sectional view of a multicore fiber according to a third embodiment.

### DETAILED DESCRIPTION

Hereinafter, embodiments of the present disclosure will be described in detail with reference to the drawings. Note that the present disclosure is not limited to the embodiments described below. Furthermore, in the drawings, the same or corresponding component elements are appropriately denoted by the same reference numerals, and the description thereof will not be appropriately repeated. In addition, terms not particularly defined in the present specification shall conform to the definitions and measurement methods in G. 650.1 and G. 650.2.

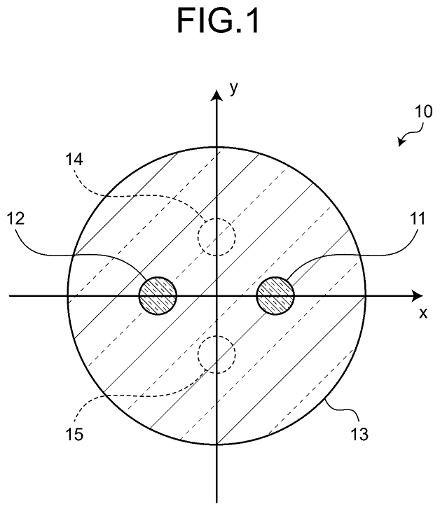

FIG. 1 is a schematic cross-sectional view of a multicore fiber according to a first embodiment, illustrating a cross-section perpendicular to a longitudinal direction of the multicore fiber. A multicore fiber 10 includes two core portions 11 and 12, a cladding portion 13, and two deformation correction portions 14 and 15. Here, the two core portions 11 and 12 are an example of a plurality of core portions, and the two deformation correction portions 14 and 15 are an example of a plurality of deformation correction portions.

The two core portions 11 and 12 are arranged in an x direction in a cross-section perpendicular to the longitudinal direction of the multicore fiber 10. Here, the x direction is an example of a first radial direction. The core portions 11 and 12 each have a substantially circular shape in the cross-section. The core portions 11 and 12 are made of, for example, silica-based glass, and may contain at least one of germanium, fluorine, chlorine, potassium, and sodium. The core portions 11 and 12 each has, but is not limited to, a refractive index profile of step shape, W-shape, trench shape, or the like. For example, the core portions 11 and 12 are arranged at equal distances from a center axis of the cladding portion 13.

The cladding portion 13 surrounds the outer peripheries of the core portions 11 and 12, and has a refractive index lower than those of the core portions 11 and 12. The cladding portion 13 is made of, for example, silica-based glass or pure silica glass, at least part of which contains fluorine. The cladding portion 13 has a substantially circular shape in the cross-section.

The two deformation correction portions 14 and 15 are arranged inside the cladding portion 13. The deformation correction portions 14 and 15 are arranged in a y direction orthogonal to the x direction, in the cross-section perpendicular to the longitudinal direction of the multicore fiber 10. Here, the y direction is an example of a second radial direction substantially orthogonal to the first radial direction. The deformation correction portions 14 and 15 have a substantially circular shape in the cross-section. The deformation correction portions 14 and 15 have refractive indices substantially the same as that of the cladding portion 13 or refractive indices lower than that of the cladding portion 13. The deformation correction portions 14 and 15 are each made of, for example, silica-based glass or pure silica glass, at least part of which contains fluorine. The deformation correction portions 14 and 15 have, for example, outer diameters that are substantially the same as outer diameters of the core portions 11 and 12. Furthermore, for example, the deformation correction portions 14 and 15 are arranged at equal distances from the center axis of the cladding portion 13. The distances of the deformation correction portions 14 and 15 from the center axis are equal to, but not necessarily equal to, for example, the distances of the core portions 11 and 12 from the center axis.

Here, the deformation correction portions 14 and 15 are different from the cladding portion 13 in stress profile or refractive index, in some cases. The stress profile is a profile indicating residual stress distribution, and is represented by a graph showing an amount of residual stress at each position in cross-section. Such a difference in stress profile can be distinguished by cutting the multicore fiber 10 to have a mirrored end surface, and observing the end surface with an optical microscope while transmitted light is in the multicore fiber 10 and epi-illumination light is in the end surface. Specifically, the difference in the stress profile provides an image, observed with the optical microscope, having a difference in gray scale. The difference in refractive index can also be distinguished by similar observation.

The multicore fiber 10 configured as described above is inhibited from having a non-circular cross-sectional shape. The reason therefor will be described below.

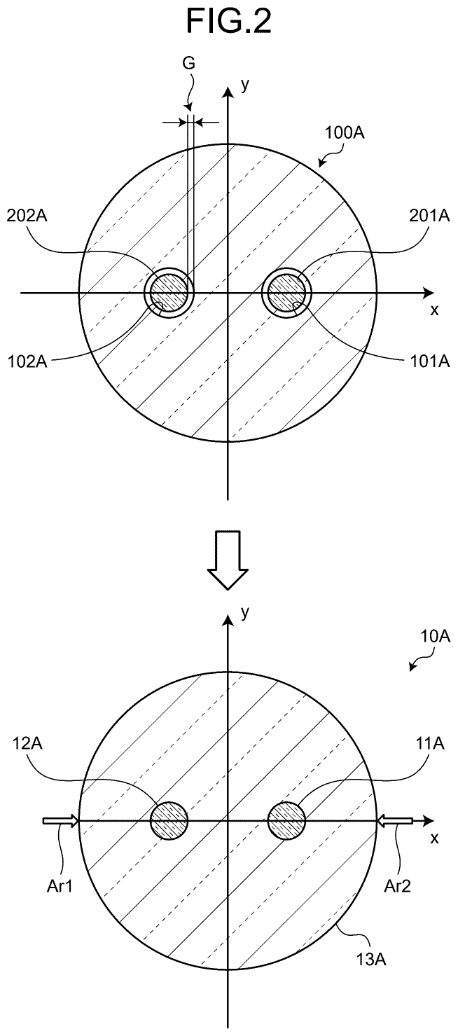

FIG. 2 is an explanatory diagram of a multicore fiber manufacturing method according to a comparative embodiment. The multicore fiber according to the comparative embodiment is a multicore fiber including two core portions, as in the multicore fiber 10 according to the first embodiment, but not including the deformation correction portions. The multicore fiber according to the comparative embodiment configured as described above is manufactured as follows. First, a glass rod 100A to be a cladding portion of the multicore fiber is prepared. Holes 101A and 102A are formed in the glass rod 100A at positions in an x direction corresponding to the core portions. Next, core rods 201A and 202A including portions to be the core portions of the multicore fiber are inserted into the holes 101A and 102A, respectively. Note that the core rods 201A and 202A may include portions to be the cladding portions of the multicore fiber. At this time, gaps G are always positioned between inner walls of the holes 101A and 102A and outer walls of the core rods 201A and 202A. This is because the core rods 201A and 202A cannot be inserted into the holes 101A and 102A unless the gaps G configured as described above are positioned. The gaps G configured as described above each has a width of, for example, 0.2 mm to 1.0 mm.

Next, when the glass rod 100A and the core rods 201A and 202A are drawn, while being heated and integrated, the gaps G are crushed to form a multicore fiber 10A including core portions 11A and 12A and a cladding portion 13A, according to the comparative embodiment. Note that the above integration and drawing may be performed in one process or may be performed in separate processes. At this time, as can be seen from FIG. 2, there are four gaps G in the x direction, and there are two gaps in the y direction orthogonal to the x direction. As a result, when the gaps G are crushed, the glass rod 100A is deformed more in the x direction than in the y direction, specifically, deformed so as to be reduced in size in directions indicated by arrows Ar1 and Ar2. Therefore, the multicore fiber 10A is deformed into an elliptical shape having a minor axis in the x direction and a major axis in the y direction in the cross-section, having a non-circular cross-sectional shape.

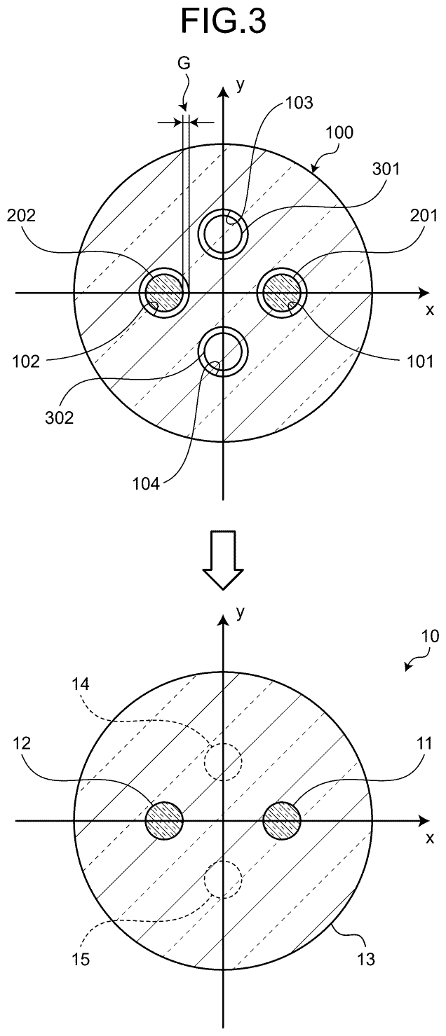

In contrast, FIG. 3 is an explanatory diagram of a multicore fiber manufacturing method according to the first embodiment. The multicore fiber 10 is manufactured as follows. First, a glass rod 100 to be a cladding portion of the multicore fiber is prepared. Holes 101 and 102 are formed in the glass rod 100 at positions in the x direction corresponding to the core portions. Furthermore, holes 103 and 104 are formed in the glass rod 100 at positions in the y direction corresponding to the deformation correction portions. Here, the holes 101 and 102 are an example of a plurality of first holes, and the holes 103 and 104 are an example of a plurality of second holes. Next, core rods 201 and 202 including portions to be the core portions of the multicore fiber are inserted into the holes 101 and 102, respectively. Furthermore, rods 301 and 302 including portions to be the deformation correction portions of the multicore fiber are inserted into the holes 103 and 104, respectively. At this time, the gaps G always positioned also between inner walls of the holes 101 to 104 and outer walls of the core rods 201 and 202 and the rods 301 and 302.

Next, when the glass rod 100, the core rods 201 and 202, and the rods 301 and 302 are drawn, while being heated and integrated, the gaps G are crushed to form the multicore fiber 10. At this time, as can be seen from FIG. 3, there are four gaps G in the x direction, and there are also four gaps in the y direction orthogonal to the x direction. As a result, when the gaps G are crushed, the glass rod 100 is substantially equally deformed in both the x direction and the y direction. As a result, the multicore fiber 10 is inhibited from having a non-circular cross-sectional shape. Note that stresses applied to the rods 301 and 302 when the gaps G are crushed in this manner are different from a stress applied to the glass rod 100, and therefore, the deformation correction portions 14 and 15 are different from the cladding portion 13, in the stress profile, in some cases.

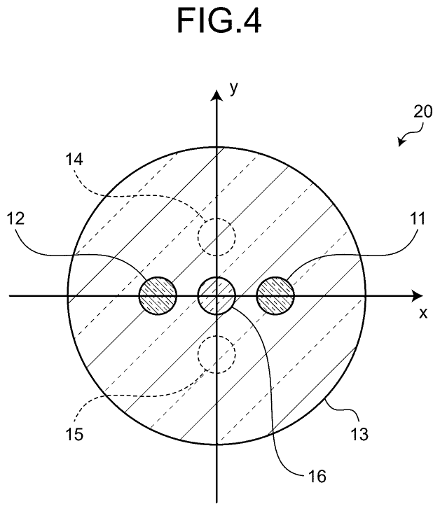

FIG. 4 is a schematic cross-sectional view of a multicore fiber according to a second embodiment, illustrating a cross-section perpendicular to a longitudinal direction of the multicore fiber. A multicore fiber 20 has a configuration in which a low-refractive index portion 16 is added to the multicore fiber 10 illustrated in FIG. 1.

The low-refractive index portion 16 is arranged between the two core portions 11 and 12. The low-refractive index portion 16 has a refractive index lower than that of the cladding portion 13. The low-refractive index portion 16 is made of, for example, silica-based glass, at least part of which contains fluorine. The low-refractive index portion 16 has a substantially circular shape in a cross-section.

The multicore fiber 20 configured as described above is inhibited from having a non-circular cross-sectional shape, and the presence of the low-refractive index portion 16 also enables reduction of inter-core crosstalk between the two core portions 11 and 12.

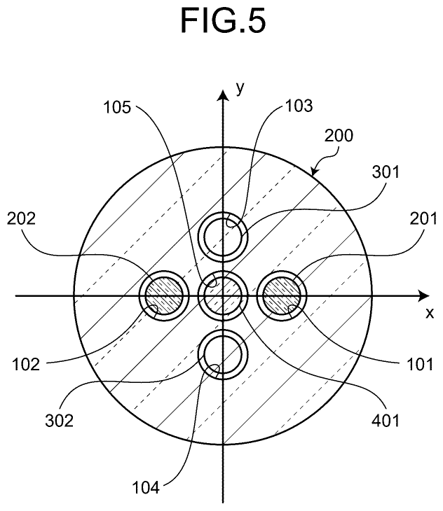

FIG. 5 is an explanatory diagram of a multicore fiber manufacturing method according to the second embodiment. The multicore fiber 10 is manufactured as follows. First, a glass rod 200 to be a cladding portion of the multicore fiber is prepared. The holes 101, 102, and a hole 105 are formed in the glass rod 200 at positions in the x direction corresponding to the core portions and the low-refractive index portion. The holes 103 and 104 are further formed in the glass rod 200 at positions in the y direction corresponding to the deformation correction portions. Next, core rods 201 and 202 including portions to be the core portions of the multicore fiber are inserted into the holes 101 and 102, respectively. Furthermore, a rod 401 including a portion to be the low-refractive index portion of the multicore fiber is inserted into the hole 105. Furthermore, rods 301 and 302 including portions to be the deformation correction portions of the multicore fiber are inserted into the holes 103 and 104, respectively.

Next, when the glass rod 100, the core rods 201 and 202, and the rods 301, 302, and 401 are drawn, while being heated and integrated, the gaps G are crushed to form the multicore fiber 20 is formed. At this time, as can be seen from FIG. 5, there are six gaps in the x direction, and there are also six gaps in the y direction orthogonal to the x direction. As a result, when the gaps are crushed, the glass rod 200 is substantially equally deformed in both the x direction and the y direction. As a result, the multicore fiber 20 is inhibited from having the non-circular cross-sectional shape.

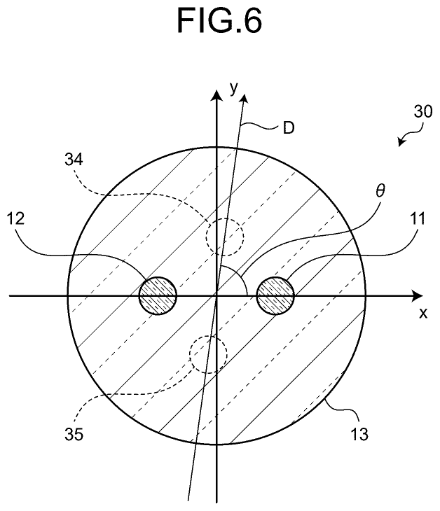

FIG. 6 is a schematic cross-sectional view of a multicore fiber according to a third embodiment, illustrating a cross-section perpendicular to a longitudinal direction of the multicore fiber. A multicore fiber 30 has a configuration in which the deformation correction portions 14 and 15 of the multicore fiber 10 illustrated in FIG. 1 are replaced with deformation correction portions 34 and 35.

The deformation correction portions 34 and 35 are arranged in a D direction forming an angle θ different from 90° with respect to the x direction, in a cross-section perpendicular to the longitudinal direction of the multicore fiber 10. Here, the D direction is an example of the second radial direction substantially orthogonal to the first radial direction. The deformation correction portions 34 and 35 each have a substantially circular shape in the cross-section. The deformation correction portions 34 and 35 have refractive indices substantially the same as that of the cladding portion 13 or refractive indices lower than that of the cladding portion 13. The deformation correction portions 34 and 35 are each made of, for example, silica-based glass or pure silica glass, at least part of which contains fluorine. The deformation correction portions 34 and 35 have, for example, outer diameters that are substantially the same as outer diameters of the core portions 11 and 12. Furthermore, for example, the deformation correction portions 34 and 35 are arranged at equal distances from the center axis of the cladding portion 13. The distances of the deformation correction portions 34 and 35 from the center axis are equal to, but not necessarily equal to, for example, the distances of the core portions 11 and 12 from the center axis.

The multicore fiber 30 configured as described above is also allowed to be manufactured by the manufacturing method illustrated in FIG. 3, and inhibited from having a non-circular cross-sectional shape. The x direction and the D direction preferably form an angle between 80° and 100°. In other words, in the present specification, the second radial direction substantially orthogonal to the first radial direction means that the first radial direction and the second radial direction form an angle between 80° and 100°.

In the above embodiments, the number of the core portions is two and the number of the deformation correction portions is two, but the present disclosure is not limited thereto. For example, if the low-refractive index portion 16 is replaced with a core portion in the second embodiment, a three-core multicore fiber can be achieved. For example, when an n-core multicore fiber (n is an integer of 2 or more) in which n core portions are arranged in the first radial direction, the number of the deformation correction portions is preferably n or n−1. In addition, in a further embodiment, a (n×m) core multicore fiber can be achieved in which n core portions arranged in the first radial direction are further arranged by m rows (m is an integer of 2 or more, for example, n>m) in a direction perpendicular to the first radial direction. In this configuration, the number of the deformation correction portions is preferably, for example, (n−m).

In the above embodiments, the plurality of core portions are the same type of cores having an identical structure parameter, but different types of cores having different structure parameters may be used. It is known that the different types of cores enable to suppress the inter-core crosstalk.

In the above embodiments, the inner diameters of the holes are equal to each other, but the inner diameters of the holes may be different from each other, as long as the sums of the gaps in the radial directions are substantially equal to each other.

According to the present disclosure, it is possible to implement the multicore fiber that is inhibited from having a non-circular cross-sectional shape.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multicore fiber comprising:
a plurality of core portions;
a cladding portion surrounding outer peripheries of the plurality of core portions and having a refractive index lower than the plurality of core portions; and
a plurality of deformation correction portions arranged inside the cladding portion,
wherein the plurality of core portions are arranged in a first radial direction in a cross-section perpendicular to a longitudinal direction of the multicore fiber, and
the plurality of deformation correction portions are arranged in a second radial direction substantially orthogonal to the first radial direction, in the cross-section.

2. The multicore fiber according to claim 1, wherein the plurality of deformation correction portions are different from the cladding portion in a stress profile or in a refractive index.

3. The multicore fiber according to claim 1, wherein the plurality of core portions and the plurality of deformation correction portions are two in number.

4. The multicore fiber according to claim 3, further comprising a low-refractive index portion arranged between two of the core portions and having a refractive index lower than the cladding portion.

5. A multicore fiber manufacturing method for manufacturing the multicore fiber according to claim 1, the multicore fiber manufacturing method comprising:
inserting core rods including portions to be the core portions, into a plurality of first holes of a glass rod having the plurality of first holes arranged in the first radial direction and a plurality of second holes arranged in the second radial direction;
inserting rods including portions to be the deformation correction portions, into the plurality of second holes of the glass rod;
integrally heating the glass rod, the core rods, and the rods; and
drawing the integrated glass rod, core rods, and rod to form the multicore fiber.

6. The multicore fiber manufacturing method according to claim 5, wherein the plurality of deformation correction portions are different from the cladding portion in a stress profile or in a refractive index.

7. The multicore fiber manufacturing method according to claim 5, wherein the plurality of core portions and the plurality of deformation correction portions are two in number.

8. The multicore fiber manufacturing method according to claim 7, wherein multicore fiber further includes a low-refractive index portion arranged between two of the core portions and having a refractive index lower than the cladding portion.
